(19) United States
(12) Patent Application Publication
(10) Pub. No.: US 2021/0266027 A1
(43) Pub. Date: Aug. 26, 2021

(54) PROTECTIVE CASES FOR MOBILE DEVICES

(71) Applicant: Incipio, LLC, Irvine, CA (US)

(72) Inventor: Andy Fathollahi, Corona Del Mar, CA (US)

(73) Assignee: Incipio, LLC, Irvine, CA (US)

(21) Appl. No.: 17/316,675

(22) Filed: May 10, 2021

Related U.S. Application Data
(63) Continuation of application No. 17/103,917, filed on Nov. 24, 2020.
Application No. 17/103,917 is a continuation-in-part of application No. 14/292,497, filed on May 30, 2014, now Pat. No. 10,848,194.
Application No. 14/292,497 is a continuation of application No. 12/540,316, filed on Aug. 12, 2009, now Pat. No. 8,800,762.

(51) Int. Cl. H04B 1/3888

(52) U.S. Cl. CPC H04B 1/3888; A45C 2011/003; Y10T 29/49826

(57) ABSTRACT

A protective case for a mobile device having a multi-layered construction is disclosed herein. The protective case includes a flexible inner sleeve for conformingly surrounding the mobile device and a rigid shell for engaging the flexible inner sleeve. The flexible inner sleeve conforms to, and encapsulates, the mobile device. The rigid shell receives and engages the inner sleeve. The flexible inner sleeve and the rigid shell ma be used separately or may be used as an integrated protective unit to protect a mobile device.

### CROSS-REFERENCE TO RELATED APPLICATIONS

This application is a continuation of U.S. patent application Ser. No. 17/103,917, filed on Nov. 24, 2020, which is a continuation-in-part of U.S. patent application Ser. No. 14/292,497, filed on May 30, 2014 and issued as U.S. Pat. No. 10,848,194 on Nov. 24, 2020, which is a continuation of U.S. patent application Ser. No. 12/540,316, filed on Aug. 12, 2009 and issued as U.S. Pat. No. 8,800,762 on Aug. 12, 2014, the entireties of which are hereby incorporated herein by reference.

### BACKGROUND

### Field of the Invention

The. present disclosure relates to user removable protective cases for mobile devices

### Description of the Related Art

Mobile devices, such as smartphones, tablets, laptops, and the like are known to sustain damage from impact and from contamination as a result of the ingress of water or other fluids. Such damage may result, for example, in a cracked screen, scratches on a finished surface, lost or damaged buttons or controls, cracked or bent external body components and/or failed or malfunctioning electrical components. Protective cases can protect mobile devices from such damage and other types of damage.

There remains a continuing need for improved protective cases for mobile devices.

### SUMMARY

A protective case for a mobile device having a multi-layered construction is disclosed herein. The protective case includes a flexible it sleeve for conformingly surrounding tb e mobile device and a rigid shell for engaging the flexible inner sleeve.

In some embodiments, the flexible inner sleeve has a screen aperture and a plurality of indents, the screen, aperture is configured such that the flexible inner sleeve cam receive the mobile device through the screen aperture, and the rigid shell has a plurality of fingers, where each finger engages a corresponding indent on the flexible inner sleeve.

In some embodiments, the flexible inner sleeve includes a screen aperture and at least one protrusion for manipulating a mobile device control or knob. The screen aperture is configured such that the flexible inner sleeve can receive the mobile device through the screen aperture. The flexible inner sleeve has a plurality of secondary apertures, where each secondary aperture is aligned with a respective mobile device connection port to allow connecting the mobile device to an auxiliary device. The rigid shell receives the flexible inner sleeve to form an integrated protective case. The rigid shell also includes a plurality of apertures which align with the secondary apertures of the inner sleeve. The inner sleeve or the rigid shell may be used independently to protect a mobile device, or alternatively, the inner sleeve and the rigid shell may be combined to provide an integrated protective unit for the mobile device.

In some embodiments, the protective case is a sleeve that includes a sheath having a backing and a plurality of edges. The sleeve has a face portion and a backing portion. The sleeve defines a first protrusion and a second protrusion which respectively correspond to a first control and a second control of the mobile device, where the sheath engagingly receives the sleeve between the plurality of edges, and where the sheath includes a first cavity and a second cavity for receiving the first protrusion and the second protrusion, respectively.

### BRIEF DESCRIPTION OF THE DRAWINGS

FIG. 1 is a perspective view of a conventional mobile device.

FIG. 2A is a perspective view of a an embodiment of the disclosed flexible inner sleeve.

FIG. 2B is a perspective view of an embodiment of a rigid shell for use with the flexible inner sleeve of FIG. 2A.

FIG. 3A is a top perspective view of an embodiment of the disclosed flexible inner sleeve.

FIG. 3B is a bottom plan view of the flexible inner sleeve of FIG. 3A.

FIG. 3C is a perspective inside view of an embodiment of a rigid shell for use with the flexible inner sleeve of FIGS. 3A and 3B.

FIG. 4 is a perspective view of a mobile device enclosed in the flexible inner sleeve of FIG. 2A.

FIG. 5 is a perspective view of a mobile device enclosed in the flexible inner sleeve of FIG. 2A and the rigid shell of FIG. 2B.

FIG. 6 shows a mounting bracket for use with an embodiment of the disclosed protective case.

FIG. 7A is a top perspective view of an embodiment of the disclosed flexible inner sleeve.

FIG. 7B is a bottom plan view of the flexible inner sleeve of FIG. 3A.

FIG. 7C is a perspective inside view of an embodiment of a rigid shell for use with the flexible inner sleeve of FIGS. 7 A and 7B.

FIG. 8 shows a mounting bracket for use with an embodiment of the disclosed protective case.

FIG. 9 shows a mounting bracket for use with an embodiment of the disclosed protective case.

### DETAILED DESCRIPTION OF THE ILLUSTRATED EMBODIMENTS

A protective case for a mobile device having a multi-layered construction is disclosed herein. The protective case includes a flexible inner sleeve for conformingly surrounding the mobile device and a rigid shell for engaging the flexible inner sleeve.

In some embodiments, the flexible inner sleeve has a screen aperture and a plurality of indents, the screen aperture is configured such that the flexible inner sleeve cam receive the mobile device through the screen aperture, and the rigid shell has a plurality of fingers, where each finger engages a corresponding indent on the flexible inner sleeve.

In some embodiments, the flexible inner sleeve includes a screen aperture and at least one protrusion for manipulating a mobile device control or knob. The screen aperture is configured such that the flexible inner sleeve can receive the mobile device through the screen aperture. The flexible inner sleeve has a plurality of secondary apertures, where each secondary aperture is aligned with a respective mobile device connection port to allow connecting the mobile device to an auxiliary device. The rigid shell receives the flexible inner sleeve to form an integrated protective case. The rigid shell also includes a plurality of apertures which align with the secondary apertures of the inner sleeve. The inner sleeve or the rigid shell may be used independently to protect a mobile device, or alternatively, the inner sleeve and the rigid shell may be combined to provide an integrated protective unit for the mobile device.

In some embodiments, the protective case is a sleeve that includes a sheath having a backing and a plurality of edges. The sleeve has a face portion and a backing portion. The sleeve defines a first protrusion and a second protrusion which respectively correspond to a first control and a second control of the mobile device, where the sheath engagingly receives the sleeve between the plurality of edges, and where the sheath includes a first cavity and a second cavity for receiving the first protrusion and the second protrusion, respectively.

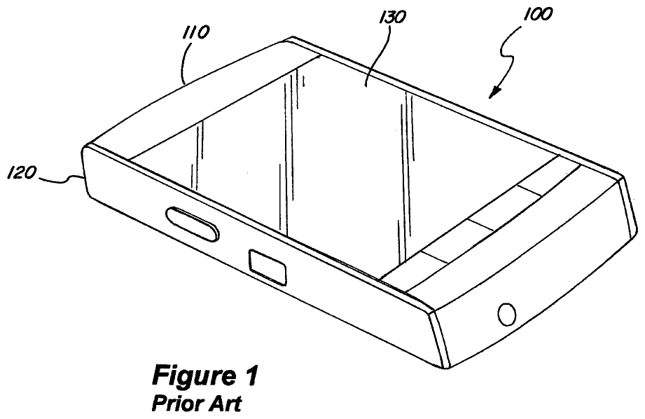

FIG. 1 is a perspective view of a conventional mobile device 100. Mobile device 100 may, for example, be a smartphone.

Mobile device 100 is shown with a top surface 110 and a side surface 120. Display 130 is conventionally integrated into the mobile device 100 and defines a screen which may, for example, be a touchscreen.

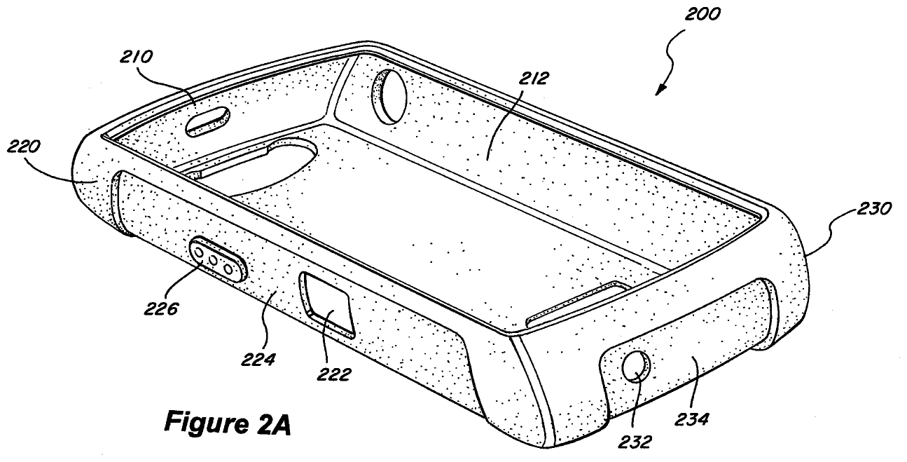

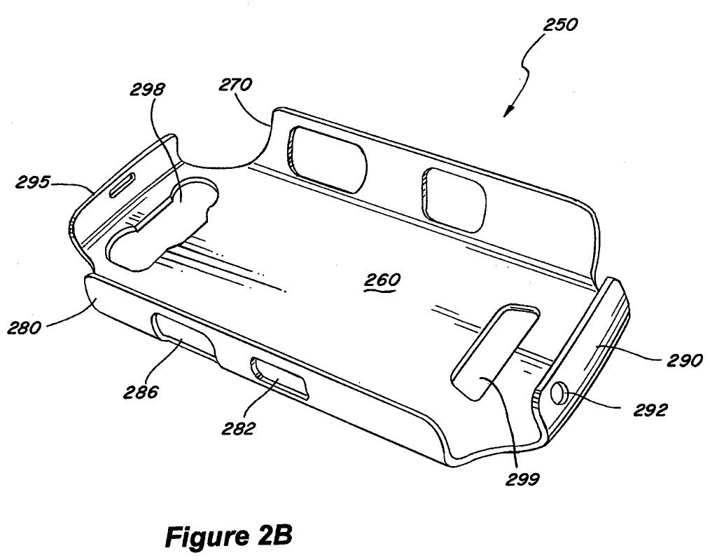

FIG. 2A is a perspective view of a flexible inner sleeve 200 for surrounding a mobile device 100. Flexible inner sleeve 200 may be molded to have the same shape and configuration as the mobile device it protects. Flexible inner sleeve 200 may be formed from a polymeric or rubber material with suitable elasticity. In some embodiments, the polymeric material includes silicon-based polymer and/or rubber material. Flexible inner sleeve 200 may also be formed front a foam-type elastic material. The elasticity of die flexible inner sleeve 200 provides several functionalities. First, the elastic polymer is soft to touch and provides excellent grip. Second, it protects against accidental dropping or other damage to the underlying mobile device. Finally, the elasticity enables the flexible inner sleeve 200 to be stretched or slipped over the mobile device.

In FIG. 2A, the flexible inner sleeve 200 includes top surface 210 and side surfaces 220 and 230. Top surface 210 includes screen aperture or opening 212. In some embodiments, the screen aperture or opening 212 is large enough to provide unobstructed access to and view of the display screen of the mobile device. The screen aperture or opening 212 may be configured to be large enough to expose the entire mobile device screen but also small enough to cover the remaining portions of the mobile device. The top surface 210 forms an edge around the entire screen aperture or opening 212 to hold the mobile device within the flexible inner sleeve 200.

Side surface 220 includes side edge 224. Side edge 224 may be indented to releasably engage a rigid shell. In some embodiments, side edge 224 defines a mortise which may lockingly engage an edge of a rigid shell. In other embodiments, side edge 224 includes a groove for receiving and engaging a notch formed on the rigid shell. Side surface 220 also includes aperture 222 and protrusion 226. Aperture 222 may be formed on inner sleeve 200 to match and align with a port or an opening in the mobile device. The mobile device port typically defines a bus or a connection jack for connecting the mobile device to an auxiliary device.

Mortise 234 is formed on side surface 230 to engageably receive a rigid shell. In some embodiments, mortise 234 defines a depression or indent on the side surface 230 of inner sleeve 200. Aperture 232 is also formed on the side surface 230 of the inner sleeve 200 to align with a port or an opening in the mobile device. The port may be configured to receive, for example, a USB data connection or a headphone. The other sides (not shown) of inner sleeve 200 may have similar mortises, protrusions, and apertures formed thereon. Depending on the configuration of the underlying mobile device, mortises may be formed on all four sides of the inner sleeve 200 or on one, two, or three sides thereof. In some embodiments, where mortises are formed on two opposing sides of the flexible inner sleeve 200, the rigid shell can releasably engage two sides of the flexible inner sleeve 200. The limited elasticity of the rigid shell and the elasticity of the flexible inner sleeve 200 allow coupling of the flexible inner sleeve 200 to the rigid shell 250.

FIG. 2B is a perspective view of a rigid shell 250 for use with the flexible inner sleeve 200 of FIG. 2A. The rigid shell 250 includes a bottom surface 260 and side surfaces (interchangeably, side edges) 270, 280, 290, and 295, Side surfaces 270 and 280 engage opposing sides of the flexible inner sleeve 200 (see FIG. 2A). Similarly, side surfaces 290 and 295 engage opposing sides of the flexible inner sleeve 200. In this manner, the side surfaces function to secure the rigid shell 250 to the flexible inner sleeve 200. The side surfaces 270, 280, 290, and 295 of the rigid shell 250 may have corner openings at the four corners to expose the flexible inner sleeve 200.

Side surface 280 includes apertures 282 and 286, which correspond to aperture 222 and protrusion 226 of the flexible inner sleeve 200 (see also FIG. 2A). Aperture 286 receives protrusion 226, allowing the user to manipulate the underlying mobile device. Similarly, when the flexible inner sleeve 200 of FIG. 2A is engaged with the rigid shell 250 of FIG. 2B, the apertures 222 and 282 are aligned to provide access to a mobile device port (not shown). The alignment in the two apertures 222 and 282 allows the mobile device port to be exposed outside of the protective device and to be connected to an auxiliary device (e.g., a computer). In some embodiments, the apertures 222 and 282 align to farm a cavity for a mobile device to protrude therefrom. Thus, the user can engage the dial without having to remove one or both of the protective devices.

Side surfaces 290 and 295 may be optionally added to grip opposing: sides of the flexible inner sleeve 200. Side surface 290 includes an aperture 292 which aligns with aperture 232 of FIG. 2A. The apertures 232 and 292 may be used for a camera lens in the mobile device. When the flexible inner sleeve 200 of FIG. 2A is aligned with the rigid shell 250 of FIG. 2B, the apertures 232 and 292 provide access to the mobile device port. The hard shell 250 and the flexible inner sleeve 200 may be configured to follow the contours of the underlying mobile device. In some embodiments, the flexible inner sleeve 200 follows the contours of the mobile device and the hard shell 250 follows the contours of the flexible inner sleeve 200. When assembled, the two-part protection system (i.e., the hard shell and the flexible inner sleeve) does not add substantially to the overall size and weight of the device.

Aperture 298 may be optionally added to receive a bracket for connecting rigid shell 250 to an outside mount. Aperture 298 may be replaced by a clip or any other suitable mounting apparatus which allows attaching the mobile device to a belt or pockets. While not shown, the flexible inner sleeve may also include similar configuration for attaching directly to clothing. Aperture 299 may be used to mate with a corresponding protrusion on flexible inner sleeve 200 to allow for better securement and releasing of the two parts.

While FIGS. 2A and 2B show four surfaces for engaging hard shell 250 to flexible inner sleeve 200, other configurations are also possible. In some embodiments, the hard shell 250 may be configured to engage e flexible inner sleeve 200 at two or more of its sides or corners. In other embodiments, the hard shell 250 may be configured to engage the flexible inner sleeve 200 at only two edges. in still other embodiments, the hard shell may be designed to slidingly receive the flexible inner sleeve by forming a tongue-and-groove feature with the inner sleeve. In yet other embodiments, the flexible inner sleeve may be snapped into place using one or more coupling points with the rigid shell.

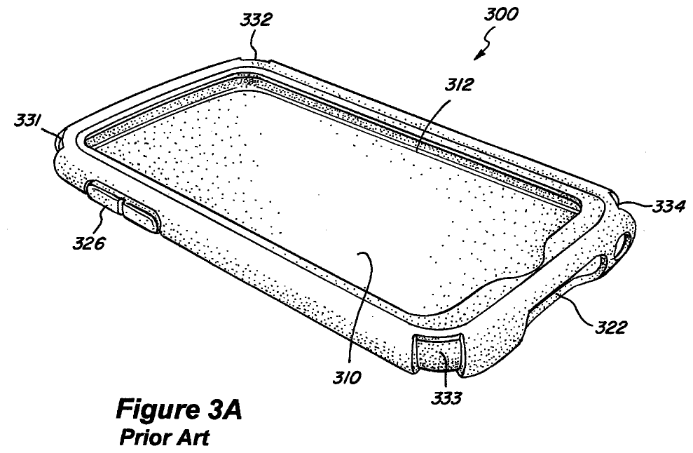

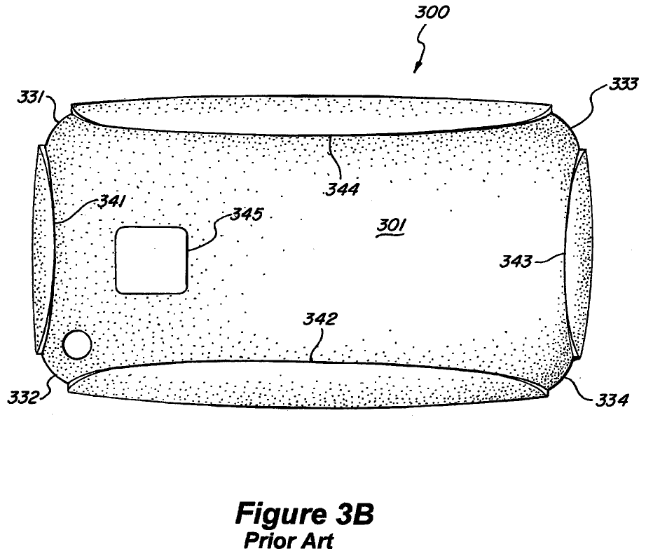

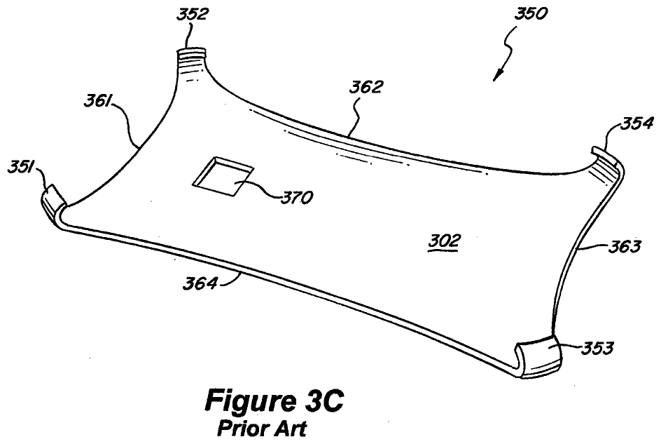

FIG. 3A is a perspective view of a prior art flexible inner sleeve 300 for surrounding a mobile device 312. The flexible inner sleeve 300 is designed to conform to the contours of the mobile. device 312 (e.g., an iPhone™). The mobile device 312 includes display and keyboard sections on the thee hereof. The flexible inner sleeve 300 is made of a soft-touch silicon lining to protect the mobile device 312 from shocks or other static electricity. The flexible inner sleeve 300 includes apertures 310 and 322. Aperture 310 receives the mobile device 317 Aperture 322 provides an opening for accessing a mobile device port. Protrusion 326 is positioned over a mobile device control, such as a volume control. Protrusion 326 allows the user to effect a change in the mobile device by pressing the protrusion. The change may be, .for example, increasing or decreasing the volume of the mobile device. Protrusion 326 has two parts, corresponding to the volume increase and decrease buttons of the mobile device. The flexible inner sleeve 300 includes four indents 331, 332, 333, and 334 at its four corners. The four indents 331, 332, 333, and 334 mate with the four fingers 351, 352, 353, and 354, respectively, on the; hard shell 350 to protect the four corners from accidental dropping of the mobile device 312.

FIG. 3B is a bottom plan view of the flexible inner sleeve 300 of FIG. 3A. The flexible inner sleeve 300 includes a bottom surface 301 that mates with an inner surface 302 of a rigid shell 350 (see also FIG. 3C). Four outer convex raised portions 341, 342, 343, and 344 surround the bottom surface 301. The outer convex raised portions 342 and 344 allow the user to grab the soft flexible inner sleeve 300 while still providing the hard protection of the rigid shell 350. The flexible inner sleeve 300 includes a center raised portion 345 to snugly mate with an opening 370 on the rigid shell 350 to provide a better connection between the flexible inner sleeve 300 and the rigid shell 350.

FIG. 3C is a perspective view of a prior art rigid shell 350 for use with the flexible sleeve 300 of FIGS. 3A and 3B. The rigid shell 350 is a hard or rigid acrylic shell that engages the mobile device 312 through the flexible inner sleeve 300. The rigid shell 350 includes four fingers 351, 352, 353, and 354 to grab, attach to, or fit into the four indents 331, 332, 333, and 334 of the flexible inner sleeve 390 of FIGS. 3A and 3B. The four fingers 351, 352, 353, and 354 provide protection to the four corners of the mobile device. The rigid shell 350 also has four concave sides 361, 362, 363, and 364 to snugly fit against the corresponding outer convex raised portions 341, 342, 343, and 344, respectively, when attached to the flexible inner sleeve 300. The rigid shell 350 does not cover the sides (i.e., the four outer convex raised portions 341, 342, 343, and 344) but does cover the bottom surface 301 of the flexible inner sleeve 309. Exposing the four outer convex raised portions 341, 342, 343, and 344 of the flexible inner sleeve 300 allows the user to have a better grip while still providing the rigid shell 350 to protect the mobile device 312.

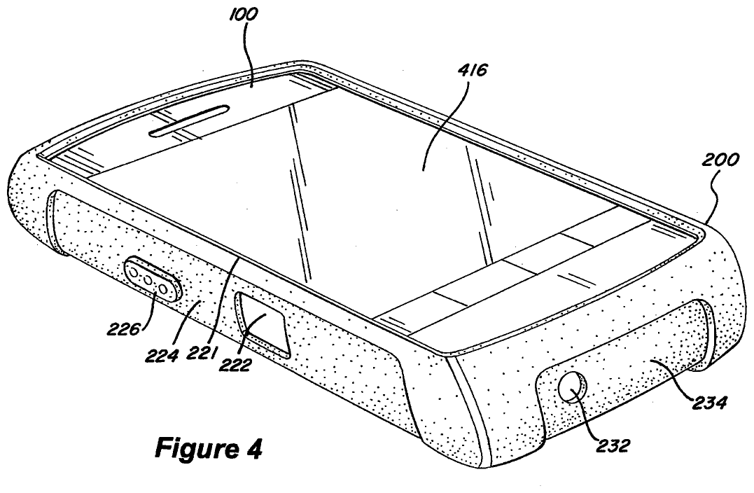

FIG. 4 is a perspective view of a mobile device 100 enclosed in the flexible inner sleeve 200 of FIG. 2A. In FIG. 4, the mobile device 109 is inserted inside the flexible inner sleeve 209 through the screen aperture 212. Protrusion 226 aligns with a control knob (not shown) of the mobile device 100 and the aperture 222 provides an opening to access a mobile device port 414. Screen 416 of the mobile device 100 is readily accessible to a user.

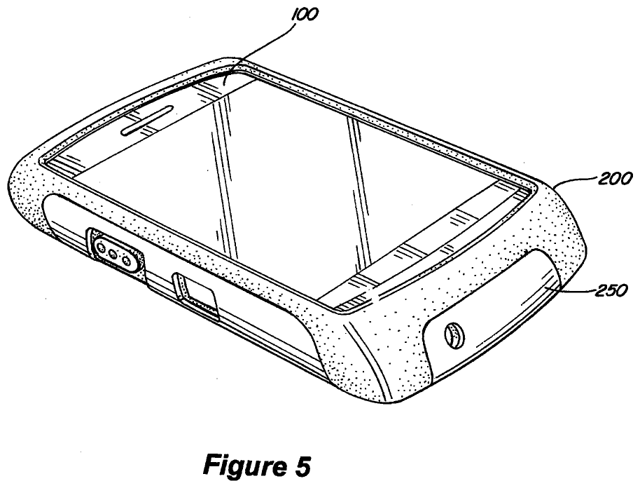

FIG. 5 is a perspective view of a mobile device 100 enclosed in the flexible inner sleeve 200 of FIG. 2A and the rigid shell 250 of FIG. 2B. Specifically, FIG. 5 shows the flexible inner sleeve 200 containing the mobile device 100. The combination of the flexible inner sleeve 200 and the rigid shell 250 protect the mobile device 100 while allowing immediate access to the buttons and screen of the mobile device 100. The flexible inner sleeve 200 is snugly fit around the mobile device 190 and the rigid shell 250 is snapped or attached to the flexible inner sleeve 200. The combination of the rigid shell 250 and the flexible inner sleeve 200 may be coupled to the user through a clip (not shown).

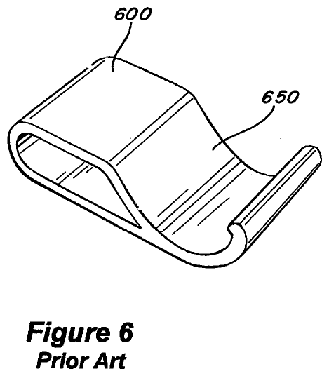

FIG. 6 shows a prior art mounting bracket 600. The mounting bracket 600 has a curved portion 650 for receiving the mobile device 100.

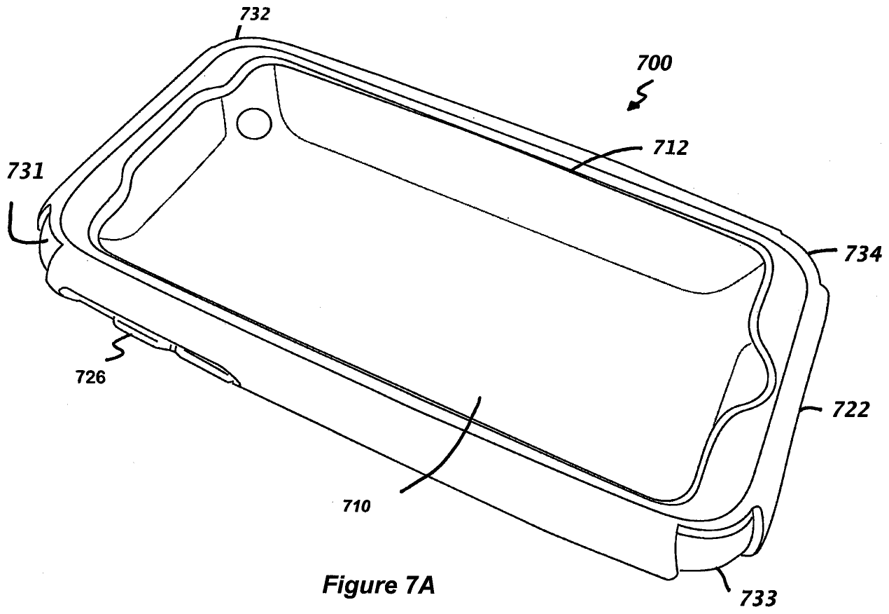

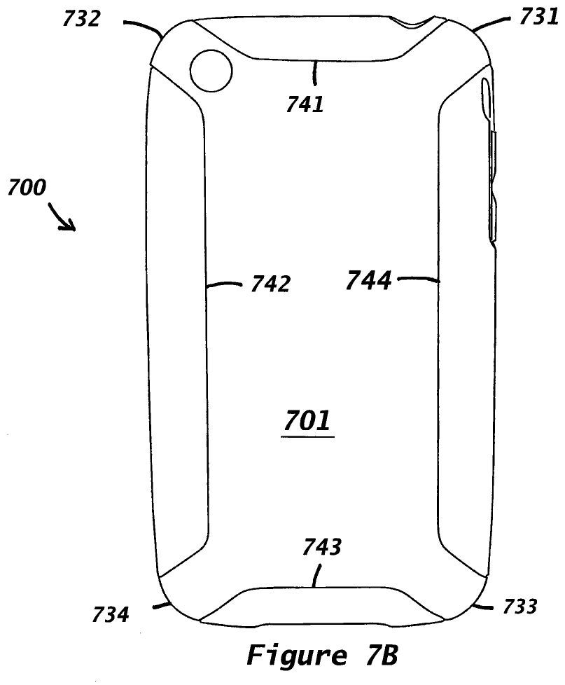

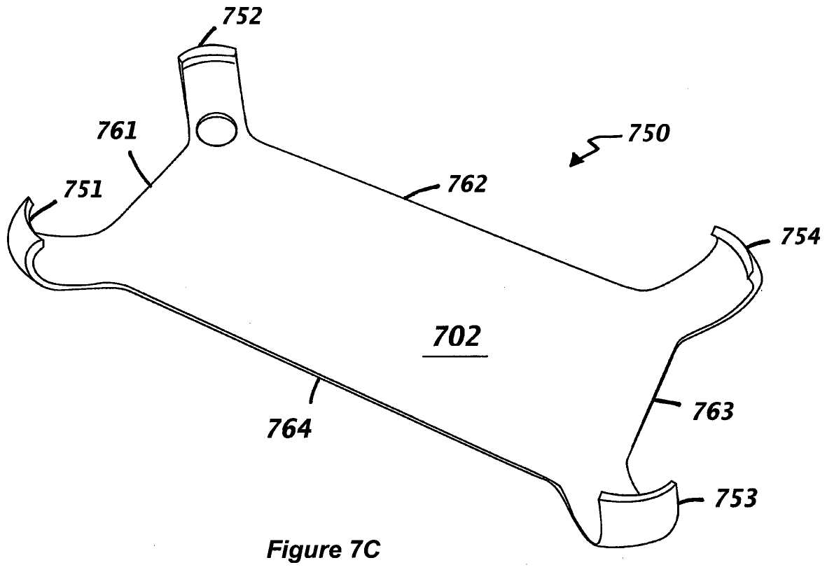

FIG. 7A is a top perspective view of a flexible inner sleeve 700 for surrounding a mobile device 712. The flexible inner sleeve 700 is designed to conform to the contours of the mobile device 712 (e.g., an iPhone™). The mobile device 712 includes display and keyboard sections on the face thereof. The flexible inner sleeve 700 may be made of a soft touch silicon rubber lining to protect the mobile device 712 from shocks or other static electricity. The flexible inner sleeve 700 includes apertures 710 and 722. Aperture 710 receives the mobile device 712. Aperture 722 provides an opening for accessing a mobile device port. Protrusion 726 is positioned over a mobile device control, such as volume control. Protrusion 726 allows the user to effect a change in the mobile device 712 by pressing the protrusion 726. The change may be, for example, increasing or decreasing the volume of the mobile device 712. In some embodiments, protrusion 726 is configured to have two parts corresponding to volume increase and decrease buttons of the mobile device. The flexible inner sleeve 700 includes four indents 731, 732, 733, and 734 at its four corners. The four indents 731, 732, 733, and 734 mate with the four fingers 751, 752, 753, and 754, respectively, on the hard shell 750 to protect the four corners of the mobile device 712 from accidental dropping of the mobile device 712.

FIG. 7B is a bottom plan view of the flexible inner sleeve 709 of FIG. 7A. The flexible inner sleeve 700 includes a bottom surface 701 that mates with an inner surface 702 of a rigid shell 750 (see also FIG. 7C). Four outer raised portions 741, 742, 743, and 744 surround the bottom surface 701. The outer raised portions 742 and 744 allow a user to grab the soft flexible inner sleeve 700 while still providing the hard protection of the rigid shell 750.

FIG. 7C is a perspective view of a rigid shell 750 for use with the flexible inner sleeve 700 of FIGS. 7 A and 7B. The rigid shell 750 may be a hard or rigid, acrylic shell configured to engage the mobile device 712 directly or through the flexible inner sleeve 700. The rigid shell 750 includes four fingers 751, 752, 753, and 754 to grab, attach to, or fit into the four indents 731, 732, 733, and 734 of the flexible inner sleeve 700 of FIGS. 7A and 7B. The four fingers 751, 752, 753, and 754 provide protection to the four corners of the mobile device. The rigid shell 750 also has four sides 761, 762, 763, and 764 to snugly fit against the corresponding outer raised portions 741, 742, 743, and 744, respectively, when attached to the flexible inner sleeve 700. In some embodiments, the rigid shell 750 does not cover the sides (i.e., the four outer convex raised portions 741, 742, 743, and 744) but does cover the bottom surface 701 of the flexible inner sleeve 700. Exposing the four outer raised portions 741, 742, 743, and 744 of the flexible inner sleeve 700 allows the user to have a better grip while still providing the rigid shell 750 to protect the mobile device 712.

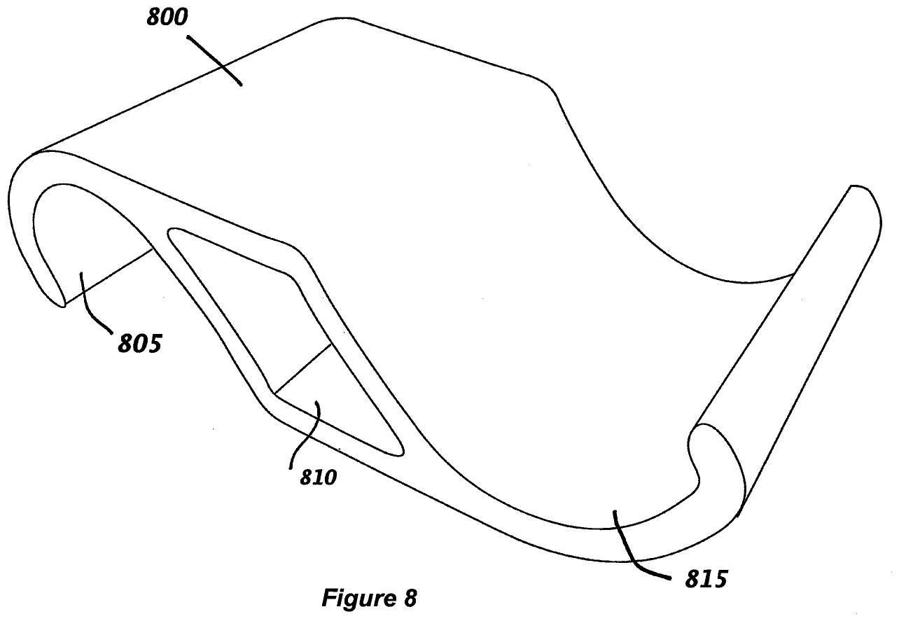

FIG. 8 shows a mounting bracket 800 for use with an exemplary protective case. The mounting bracket 800 is formed in the shape of a “Z” and may have a curved portion 815 for receiving the mobile device 100. The mounting bracket 809 has a similar curved portion 805 on the other side. In sonic embodiments, the mounting bracket 800 has an opening 810 positioned between the two curved portions 805 and 815.

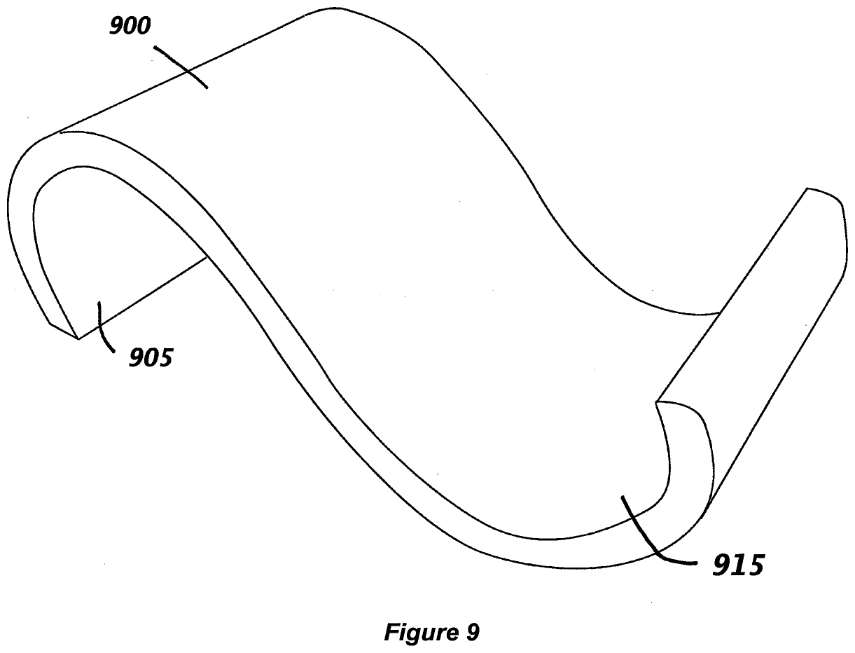

FIG. 9 shows a mounting bracket 900 for use with an exemplary protective case. The mounting bracket 900 is formed in the shape of an “S” and may have a curved portion 915 for receiving the mobile device 100. The mounting bracket 909 has a similar curved portion 905 on the other side.

The previous description of the disclosed embodiments is provided to enable an person skilled in the art to make or use the invention disclosed herein. Although the various inventive aspects are disclosed in the context of certain illustrated embodiments, implementations, and examples, it should be understood by those skilled in the art that the invention extends beyond the specifically disclosed embodiments to other alternative embodiments and/or uses of the invention and obvious modifications and equivalents thereof. In addition, while a number of variations of various inventive aspects have been shown and described in detail, other modifications that are within their scope will be readily apparent to those skilled in the art based upon reviewing this disclosure. It should be also understood that the scope of this disclosure includes the various combinations or sub-combinations of the specific features and aspects of the embodiments disclosed herein, such that the various features, modes of implementation, and aspects of the disclosed subject matter may be combined with or substituted for one another. The generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Similarly, the disclosure is not to be interpreted as reflecting an intent that any claim set forth below requires more features than are expressly recited in that claim. Rather, as the following claims reflect, inventive aspects may reside in a combination of fewer than all features of any single foregoing, disclosed embodiment.

Each of the foregoing and various aspects, together with those set forth in the claims and summarized above or otherwise disclosed herein, including the figures, may be combined without limitation to form claims for a device, apparatus, system, method of manufacture, and/or method of use.

All references cited herein are hereby expressly Incorporated by reference.

What is claimed is:

1. A protective case for a mobile device configured to be in contact with all sides of a mobile device, wherein the mobile device has a flat front surface, a flat back surface, and side surfaces extending between the front and back surfaces, the protective case comprising:
a flexible inner sleeve configured to engage and surround a mobile device, including the back surface and the side surfaces of the mobile device, the flexible inner sleeve comprising a front surface, a back surface, and side surfaces extending between the front and hack surfaces, including top, bottom, right, and left side surfaces, the flexible inner sleeve further comprising an indention extending continuously from the back surface to the top, bottom, right, and left side surfaces of the flexible inner sleeve, wherein the height. of said indention on at least one of the top, bottom, right, and left side surfaces of the flexible inner sleeve, as measured between the front and back surfaces, is less than the height of the indention extending on one or more of the other sides of the flexible inner sleeve, and wherein the flexible inner sleeve further includes a protrusion configured to overlie in contact with a control button on the mobile device; and
a rigid outer shell releasably engaged with the flexible inner sleeve to thereby form an integrated protective unit, wherein the outer shell is configured to reside within the indention, wherein the outer shell includes an aperture dimensioned to receive the protrusion, wherein the outer shell includes multiple side walls that are configured to reside within the corresponding portions of the indention that are located on the side surfaces of the inner sleeve, and wherein at least one side wall of the outer shell is configured to reside entirely below the front surface of the mobile device when the mobile device is fully inserted within the protective case such that the back surface of the mobile device is in contact with the flat back surface of the flexible inner sleeve.

2. The protective case of claim 1, wherein when the outer shell is engaged with the flexible inner sleeve the case has an exposed edge of the flexible inner sleeve extending beyond the outer shell that surrounds and thereby defines a screen opening.

3. The protective case of claim 1, wherein the flexible inner sleeve comprises a soft polymeric material.

4. The protective case of claim 3, wherein the soil polymeric material is selected from the group consisting of a silicon-based polymer, a foamed polymer, or rubber.

5. The protective case of claim 1, wherein the outer shell comprises a hard plastic material.

6. The protective case of claim 5, wherein the hard plastic material comprises acrylic.

7. The protective case of claim 1, wherein when the outer shell is engaged with the flexible inner sleeve, the case has an exposed edge of the flexible inner sleeve not covered by the outer shell that surrounds and thereby defines the aperture.

8. The protective case of claim 7, wherein the second exposed edge includes a curved region.

9. The protective case of claim 1, wherein each of the top, bottom, right, and left sides of the flexible inner sleeve includes one or more apertures, and wherein the outer shell also includes one or more apertures that correspond to the one or more apertures of the top, bottom, right, and left sides of the flexible element.

10. The protective case of claim 1, wherein the flexible inner sleeve is configured to be removable from the outer shell.
